(19) United States
(12) Patent Application Publication
(10) Pub. No.: US 2006/0026268 A1
(43) Pub. Date: Feb. 2, 2006

(54) Systems and methods for enhancing and optimizing a user's experience on an electronic device

(76) Inventor: Frank Seiji Sanda, Tokyo (JP)

Correspondence Address: JOHN S. PRATT, ESQ;KILPATRICK STOCKTON, LLP, 1100 PEACHTREE STREET, ATLANTA, GA, 30309, US

(21) Appl. No.: 11/168,847

(22) Filed: Jun. 28, 2005

Related U.S. Application Data
(60) Provisional application No. 60/583,765, filed on Jun. 28, 2004.
(60) Provisional application No. 60/598,364, filed on Aug. 3, 2004.

(51) Int. Cl. G06F 15/177; G06F 15/173

(52) U.S. Cl. 709/221; 709/224

(57) ABSTRACT

Certain embodiments are systems and methods for intelligently managing applications, hardware, connection access, and user requirements on electronic devices and systems. One aspect includes a resource manager functionality that takes into account parameters associated with some or all of multiple communications options, applications and platform, and uses those parameters to optimize the user experience in that context based on externalities and on certain information which indicates or suggests what the user prefers. Another aspect of the present invention is a method of controlling system resources on a client device. This may involve determining application requirements for applications currently in use on the client device, determining client device resource requirements based on the application requirements, and adjusting resource settings based on the resource requirements. Another aspect of the present invention is a connection module.

### CROSS-REFERENCE TO RELATED APPLICATIONS

The present application claims priority to U.S. provisional application No. 60/583,765, entitled “Controlling Use of a Mobile Work Station Based on Network Environment,” filed on Jun. 28, 2004, U.S. provisional application No. 60/598,364 entitled “Systems and Methods for Enhancing and Optimizing a User's Experience on an Electronic Device,” filed on Aug. 3, 2004, U.S. provisional application entitled “Creating an Environment for Secure Mobile Access Anywhere” filed on Feb. 11, 2005 to Sanda et al., and U.S. provisional application entitled “Remote Access Services” filed on Feb. 16, 2005 to Sanda et al.

### FIELD OF THE INVENTION

The invention relates generally to systems, methods and functionality used in computing, telecommunication, and electronic devices. More specifically, the invention relates to intelligent management of applications, hardware, connection access, and user requirements on electronic devices and systems.

### BACKGROUND OF THE INVENTION

An increasing number of individuals use portable computers away from the home or office. The recent advent of sufficiently small processing power, memory, display and battery endurance, coupled with an increasing presence of wireless communications services, allows mobile computing to be accomplished more effectively and efficiently, whether on a notebook or laptop computer, a Personal Digital Assistant (“PDA”), telecommunications devices, or other platforms. As mobile computing gains in popularity, an increasing number of applications and communications options are made available by the power of the market, and thus a need has arisen for functionality that can manage and optimize performance based on the available hardware, software and communications options.

Thus, the increasing ubiquity of mobile computing and the need for connectivity, primarily wireless connectivity, has led to the proliferation of portable computers capable of connecting to networks in a variety of ways. These portable computers often contain one or more interfaces to several types of networks such as LANs, dial up modems, Wi-Fi wireless local area networks (WLANs), and wireless wide area networks (WWANs). These network interface modules, such as conventional communications cards or circuits within or attached to portable computers can draw significant power and significantly reduce battery life. It is inefficient and wasteful to expend battery power and system resources on hardware components that are not currently in use.

Similarly, it is inefficient to have computer components, functions and resources enabled that are not in use by the current application. Some applications require hardware or other components that other applications do not require. However, the widespread use of general-purpose operating systems that control access to the Internet and to system resources prevents applications from efficiently using the available computing resources. Specifically, resources such as high resolution displays, high-speed displays, mass memory devices and multiple Internet access connections are often enabled even when they are not required by an application. These enabled resources can drain system resources and decrease the performance and efficiency of the application.

In many cases, applications that run on a mobile computer cannot be optimized to the hardware because the operating system is necessarily independent of the hardware. An operating system does not necessarily have to be independent. In fact many, if not most, digital hardware devices, such as cell phones, digital cameras and watches as examples, feature integrated applications with their operating system and hardware in order to optimize product performance.

For many mobile computer operating systems, the hardware components are linked to the operating system with unique software called drivers. Various hardware devices, such as memory, printers, transceivers and even microprocessors have unique drivers to manage them. Generally the driver software is developed by the hardware manufacturer and is included with the purchase of the peripheral device. The relevant applications, typically through the operating system, often with considerable assistance from the user, ultimately become connected to the device by virtue of the driver.

This scheme prevents, or at least makes more difficult, the optimization of the various hardware components. An operating system cannot anticipate all of the applications and associated peripheral devices a computer will use or require, even if it can anticipate some of them. For example, if two wireless cards (Wi-Fi and a WWAN cellular system) are operative on a computer, both may be drawing power since the user has not put one to sleep, even though the operating system only sees the one that is selected.

In addition to the various communication and application parameters, users also have their own requirements and preferences that are also not adequately addressed because of the manner general-purpose operating systems control access to the Internet and to system resources. For example, a user may prefer to use as little power as possible, to run the system as quickly as possible, to connect to a network at the fastest possible connection speed regardless of cost, or to connect to the network in the cheapest available way regardless of speed.

### SUMMARY OF THE INVENTION

The present invention comprises systems and methods for intelligently managing applications, hardware, connection access, and user requirements on electronic devices and systems. One aspect includes a resource manager functionality that takes into account parameters associated with some or all of multiple communications options, applications and platform, and uses those parameters to optimize the user experience in that context based on externalities and on certain information which indicates or suggests what the user prefers. Another aspect of the present invention is a method of controlling system resources on a client device. This method may involve determining application requirements for applications currently in use on the client device, determining client device resource requirements based on the application requirements, and adjusting resource settings based on the resource requirements.

Another aspect of the present invention is a connection module such as a telecom battery. This device may include an interface for connection to an electronic device, a transceiver for communicating with a plurality of networks, a communication module for establishing connections with one network from the plurality of networks, and an access module for maintaining airtime allotments for the plurality of networks.

### BRIEF DESCRIPTION OF THE DRAWINGS

These and other features, aspects, and advantages of the present invention are better understood when the following Detailed Description is read with reference to the accompanying drawings, wherein:

FIG. 1 illustrates a functional block diagram of a system in accordance with one embodiment of the present invention;

FIG. 2 illustrates a functional block diagram of a system in accordance with an embodiment of the present invention;

FIG. 3 illustrates a functional block diagram of a system in accordance with one embodiment of the present invention;

FIG. 4 illustrates a flow diagram of a method in accordance with one embodiment of the present invention;

FIG. 5 illustrates a flow diagram of a method in accordance with one embodiment of the present invention;

FIG. 6 illustrates a flow diagram of a method in accordance with one embodiment of the present invention;

FIG. 7 illustrates a flow diagram of a method in accordance with one embodiment of the present invention;

FIG. 8 illustrates a flow diagram of a method in accordance with one embodiment of the present invention;

FIG. 9 illustrates a flow diagram of a method in accordance with one embodiment of the present invention;

FIG. 10 illustrates a flow diagram of a method in accordance with one embodiment of the present invention;

FIGS. 11a-c illustrate various connection modules in accordance with certain embodiments of the present invention; and

FIG. 12 illustrates a flow diagram of a method in accordance with one embodiment of the present invention.

### DETAILED DESCRIPTION OF SPECIFIC EMBODIMENTS

The invention provides intelligent management of applications, hardware, connection access, and user requirements on electronic devices and systems. Embodiments of the present invention manage these elements based on parameters associated with the available hardware and software resources, including the available communication or connection options. These parameters include factors such as cost, speed, bandwidth, and quality of signal, and quality of service, among others. For example, in some embodiments of the invention, a resource manager, residing in or on a client device, takes into account actual performance information regarding the applications, platforms, and communication options, and then adjusts resources at the client device to optimize the user experience based on these present conditions. As a more specific example, a resource manager may determine that a current application requires access to a network and automatically connect the device to the network via a first connection option after determining that that first connection option is optimal or otherwise preferable to others that are available. The resource manager might determine at a later time that one of the other connection options is preferable and cause the client device to automatically switch connection types. This may be done with or without user interaction or approval. The selection of a connection option may depend on the requirements of the applications currently in use, the present quality of the connections available through those connection options, and the user's preferences, among other things.

Another aspect of the present invention is a physical connection module, also referred to as a telecom battery. The connection module of the invention is a device used to add telecommunication or other network connection capability to an electronic device such as a mobile computer, a PDA, a digital camera, a music player, or a vending machine by providing one or more connections to one or more networks, whether physical connections or wireless. A connection module may provide connections by including the necessary software, hardware, and/or airtime to connect to one or more carrier networks. The connection module may also be used to add additional telecommunication capabilities to an electronic device already having some telecommunication abilities and may be used in conjunction with the resource manager functionality.

Exemplary Client Devices, Systems, and Environments

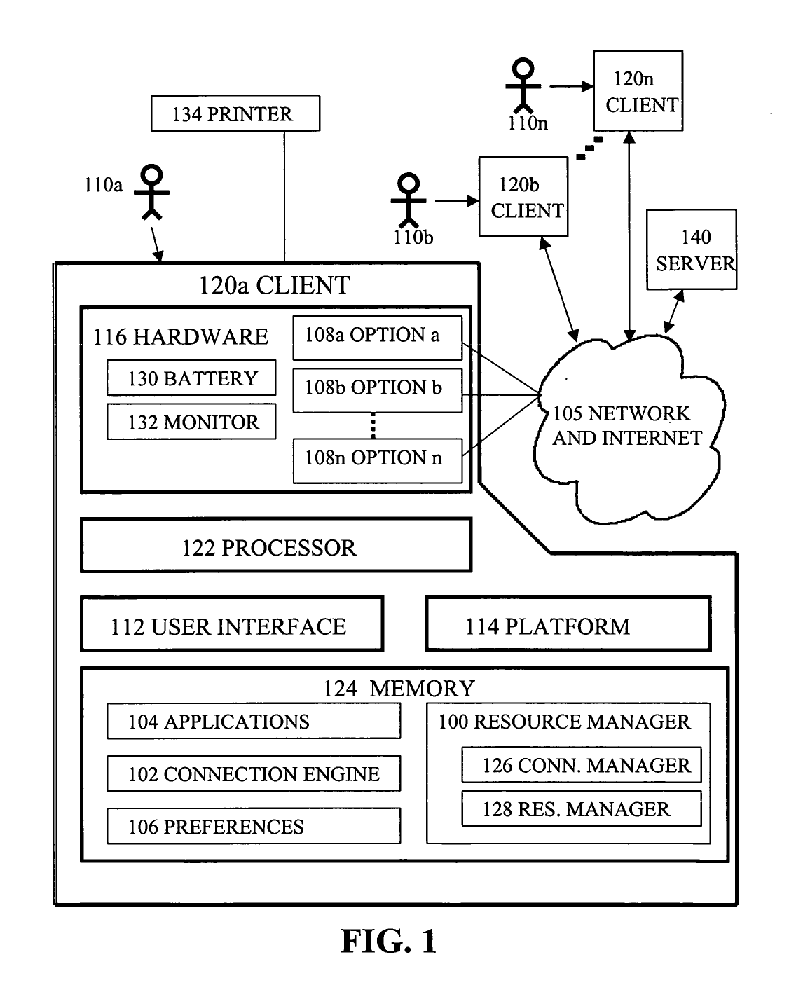

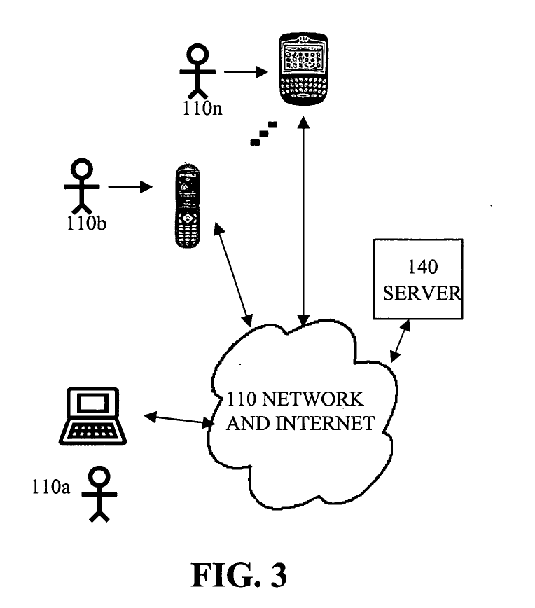

FIGS. 1, 2, and 3 illustrate functional block diagrams of client devices 120a-120n operating in network environments in accordance with various embodiments of the present invention. Client devices 120a-120n may be used by users 110a-110n for a variety of purposes and reasons. For example, a user, such as user 110a using client device 120a, may desire to use or run one or more local applications 104 residing in the memory 124 of the user's client device 120a or may desire to remotely run applications or retrieve information residing on a remote client device 120b-120n, server 140, or other computing device accessible on or through network 105. Local applications 104 may also require access to remotely located information, data, systems or process that may be accessed on or through the network 105. Accordingly, in addition to local system resource requirements, a client device 120a may have various remote access or network connection requirements.

In general, a client device 120a-n may use any suitable type of processor-based platform 114, and typically will include a processor 122 coupled to a computer-readable medium, such as memory 124, and include hardware 116 and user interface 112 components. The computer readable medium can contain program code that can be executed by the processor. It can be used to store information and applications such as a connection access engine 102, connection preferences 106, and a resource manager 100. It may also include an operating system that controls the system resources such as hardware 116 and processor 122 and provides the user interface 112.

The client devices 120a-n themselves may have differing characteristics. The client devices 120a-n may include cell phone devices, mobile phone devices, smart phone devices, pagers, notebook computers, personal computers, digital assistants, personal digital assistants, digital tablets, laptop computers, Internet appliances, blackberry devices, Bluetooth devices, standard telephone devices, fax machines, other suitable computing devices, or virtually any other electronic device. Additional components in the client devices may differ and provide various functionalities.

The client device 120a-120n may be connected to a network 105 in a variety of ways. The network 105 is not limited to any particular type of network nor is it limited to a single network. For example, the network 105 could be the Internet, a LAN, a WAN, a private network, a virtual network, or any combination of network types. The connection access options 108 may be virtually any type of network, line, or wireless connection. For example, the connection access options 108 could involve local area networks (“LANs”), dial up modems, Wi-Fi, wireless local area networks (WLANs), wireless wide area networks (WWANs), or cellular. The invention can work with any suitable connection type or types.

Exemplary Resource Manager

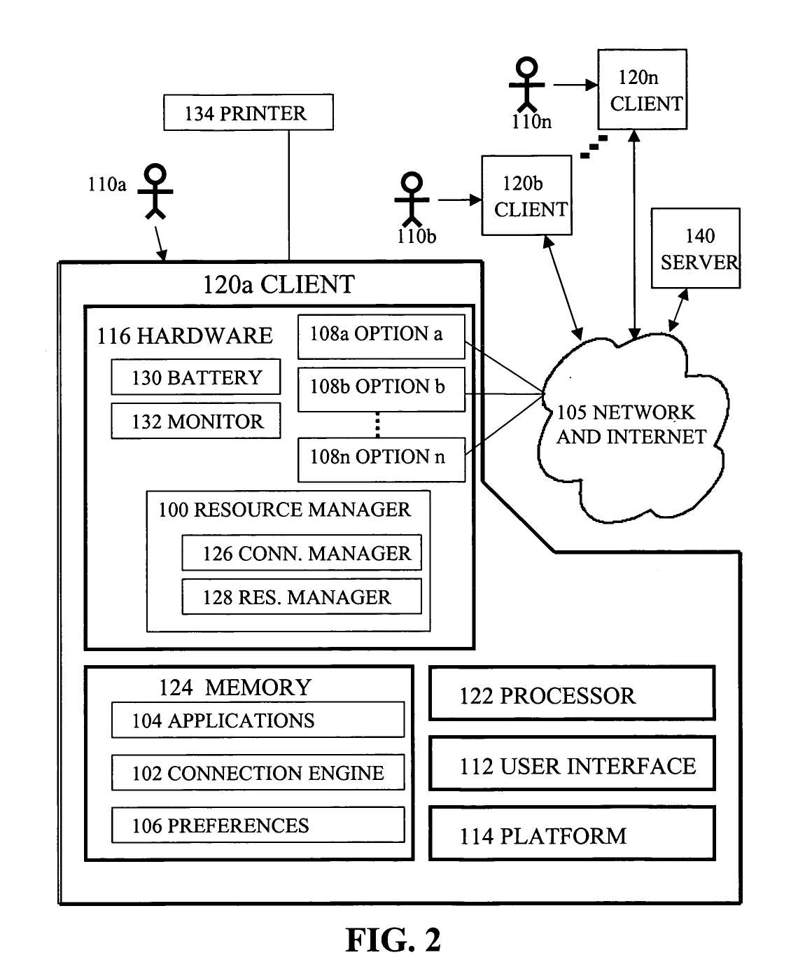

Resource manager 100 intelligently manages components and resources associated with a client device 120a including applications 104, hardware 116, connection access engine 102, and user/company preferences 106. FIGS. 1 and 2 illustrate functional block diagrams, each showing a client device 120a having a resource manager 100. In FIG. 1 the resource manager 100 is program code located in memory 124 that is executable by a processor 122, while in FIG. 2 the resource manager 100 is one of or a part of hardware components 116. This illustrates how the resource manager 100 could be coupled with communication hardware components or with other software applications residing in memory. Accordingly, the particular location of resource manager 100 may vary in different embodiments of the invention.

Even though the discussion herein primarily discusses the resource manager 100 as residing on top of an operating system, the resource manager 100 is not limited to this use. In fact, the resource manager 100 can take many forms for various operating systems, applications, hardware, types of devices, communications services options, changes and developments in technology, and other factors. It may be incorporated as part of the operating system or as part of a chip such as a processing chip. Resource manager 100 can be provided as a physical or logical plug-in, or integral to the operating system, available at a server level accessible by a mobile computer whether wireless or wire line, or as otherwise desired.

According to one embodiment of the present invention, the resource manager 100 takes the form of an easy-to-use connection access and management control engine, which controls the interaction between the operating system and the driver software in a client device and facilitates management of the hardware devices connected to the client device 120a, such as a printer 134, a monitor 132, or communication options 108a-n. Accordingly, the resource manager 100 can enhance hardware device efficiency and effectiveness using the control functions available through the hardware drivers. For example, the resource manager 100 can control the operating environment on a processing chip for a wireless communications processor, such as the Centrino™ chip from Intel Corp., and its wireless function as it relates to an application. As another example, the resource manager 100 can optimize the utilization of multiple transceivers to insure optimal performance. A third example is using the resource manager 100 to control hardware 116 based on an application's 104 particular requirements. An application 104 may require, for example, that printouts appear on a particular size of paper. Resource manager 100 can control the size of paper the attached printer 134 will use.

Resource manager 100 can take into account parameters associated with some or all of multiple connection access 108a-n options. Resource manager 100 connects the user to the appropriate networks, allowing her to use corporate networks, email, and the Internet. Resource manager 100 is intelligent and automatically connects to the appropriate network, or no network at all, depending on user (or corporate) preferences and the applications that are currently required by the user. In other words, the resource manager 100 can automatically control a mobile computer's telecommunication functions and hardware based on an application's particular telecommunication requirements and in light of the user's (or company's) preferences.

Process for Managing System Resources

Resource manager 100 can optimize a user's experience using a given computing application or applications. Resource manager 100 enhances both hardware and software performance by efficiently using system components and resources based on the specific application requirements and platform constraints and in light of the user or company preferences. Accordingly, system resources are more efficiently used on hardware and software components needed for the current application or applications.

Battery power, processing speed, printer ink, processor time, memory, and telecommunications abilities are examples of system resources associated with a client device 110a. These system resources may be found in hardware components in or associated with the client device or other related electronic devices or located remotely from the client device. The resource manager 100 may control the use of these system resources by the client device. For example, applications running on a client device may not require that the monitor display anything while a lengthy operation is running. The resource manager 100 can disable provision of power to the monitor and thereby preserve the battery power resource. This may be done even when the operating system running the application would otherwise continuously provide power to the monitor to display the operating system user interface while the application is running.

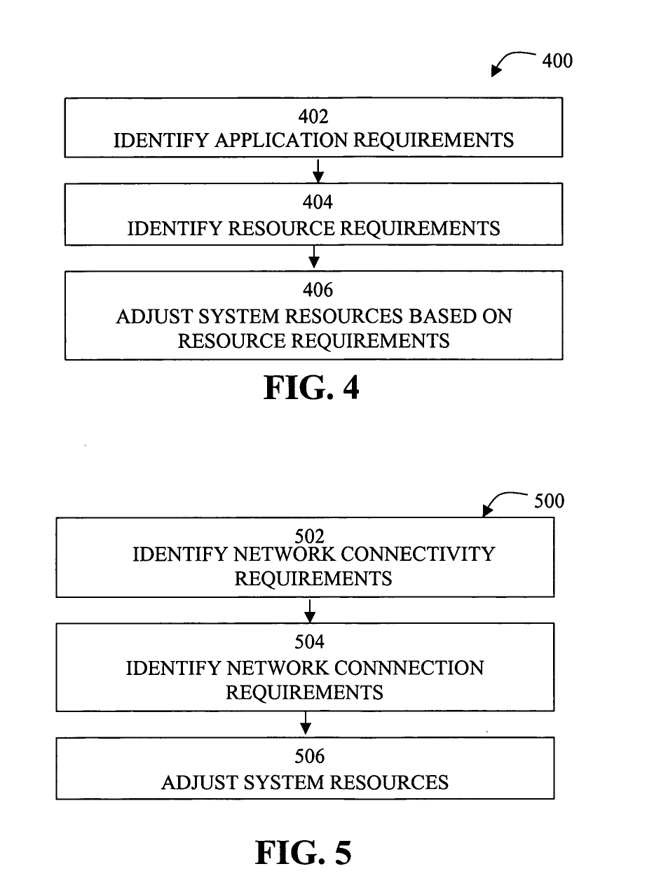

Accordingly, FIG. 4 shows one aspect of the present invention as a method 400 of controlling system resources such as hardware 116 that is not automatically adjusted by the operating system on a client device 120a. This method may be performed in part or in full by resource manager 100. For example, the resource manager 100 could reside as a software application stored on a computer readable medium, such as in memory, working to enhance the capabilities of the operating system and the system resource settings controlled by the operating system.

In block 402, application requirements are identified. These application requirements will typically be based on the applications in use on the computer device. Application requirements may be determined in a variety of ways including but not limited to by tracking system level calls, by tracking memory allocations, and/or by benchmarking application requirements for particular applications. For example, the application requirements may be determined for all applications currently in use on the client device. As a specific example, it may identify that a certain game application is currently in use on a client device.

In block 404, resource requirements are determined based on the application requirements. This will typically involve determining what potential physical and/or software resources may be used by an application. For example, this block may determine that high-resolution graphic display is required for a certain game application currently in use.

In block 406, system resources are adjusted based on the resource requirements. This may involve, for example, adjusting operating system resource settings to optimize system resource usage based on the client device system resource requirements. As a more specific example, if it has been determined that a high-resolution graphic display is required for a certain game application currently in use, system resources will be adjusted to ensure that the display is enabled and capable of providing the necessary high-resolution display. The display may be enabled by providing power to the display or by activating it through the operating system settings.

Adjusting system resources may also involve disabling system resources not required by the application requirements of the applications in use. If it has been determined that a high-resolution graphic display is all that is required for a certain game application currently in use, system resources will be adjusted to avoid wasting. Hardware resources, such as a printer, monitor, and telecommunications devices, may be disabled by discontinuing provision of power to those resources or by adjusting the operating system settings controlling them. Software resources, such as firewall software, may be halted or paused to avoid expending processing, memory, and other computational resources unnecessarily.

Another example includes a user using a portable electronic device, one type of client device having one or more connection to a network and/or the Internet. In this example, the user executes a web browser application to run a complicated search engine query or database lookup. While the web browser is waiting for a response, the resource manager 100 may disable power to the display preserving battery power. Once the search results are returned, or if the user presses a key on the device's keypad, the resource manager can restore power to the device's display. Accordingly, the monitor is put to sleep and revived based on the current application's requirements.

Process for Controlling Network Connections and Related System Resources

Resource manager 100 can also provide significant benefits to users (and user applications) requiring access to a network. First, it can automatically enable only the necessary functions and components for a given network application and disable others. Second, it can reduce or eliminate the need for a user to spend time to connect an application to one or more networks because it can automatically connect the user to the appropriate network via a connection option 108a-n that is appropriate for various parameters defined by the application, the connection option's availability, the platform the application is designed to run on, and the user or company preferences. The user may not be required to manually select a network connection option. The user's experience is, therefore, not complicated by the cumbersome details and processes needed to manually select and logon to an appropriate connection option.

For example, when a user operating a mobile computing device, a type of client device, selects to execute an application that requires Internet access such as a web browser or e-mail interface, the resource manager 100 can automatically initiate a network connection by enabling a wire or wireless connection. Conversely, when the user closes or discontinues running applications that require Internet access, for example by closing the web browser application, the resource manager 100 can disable the network connection and other associated system resources.

FIG. 5 shows one aspect of the present invention as a method of adjusting connection options 108a-n, method 500. Method 500 provides a way of controlling system resources on a computer device that specifically provides for adjustments based on network connection requirements.

In block 502, network connectivity requirements are identified. For example, application network connectivity requirements may be determined for all applications currently in use on the client device. As a more specific example, it may be determined that an e-mail application and an Internet web browser application are both in use currently and that concurrent execution of these applications requires a network connection.

In block 504, communication resource requirements are identified. For example, communication resource requirements may be determined based on application network connectivity requirements. As a more specific example, if it is determined that the e-mail and web browser applications currently in use require a network connection (application network connection requirements), it may be further determined a communication option resource (communication resource requirement) is required. Examples of communication option resources include software, modems, cards, and other devices that allow or provide a connection to a LAN, Wi-Fi, WLANs, WWAN, Internet or other network though wires, telecommunication, or other transmission types.

In block 506, system resources are adjusted. For example, system resource settings may be adjusted at the operating system level to optimize system resource usage based on the communication resource requirements. Adjusting system resources may involve selecting a connection option available on the computer device and enabling that connection option. The selection of the connection option may also be based on user and/or company preferences.

The method 500 may involve adjusting system resources based on a variety of considerations. For example, if an application in use on the device requires a network connection, resource manager 100 may identify competing resources on the device that offer this network connection capability—e.g. a Wi-Fi device and a cellular device. The resource manager 100 may select the Wi-Fi device because it currently offers higher transmission speed and because the user's preferences indicate a preference for the fastest available connection in all circumstances.

Process for Monitoring Application Requirements

A resource manager may also monitor the applications in use on the computer device and determine changes in application requirements on the computer device. System resources may then be adjusted based on the changes. The changes in application requirements may be based on changes in the applications in use on the device and the corresponding changes in requirements. For example, if the device's display has been put to sleep to preserve battery power while a web browser application awaits the results of a search engine, the resource manager 100 will recognize when the search results are returned and that the resource requirements of the applications have changed. Upon recognizing this change, the display power (the system resource) is restored.

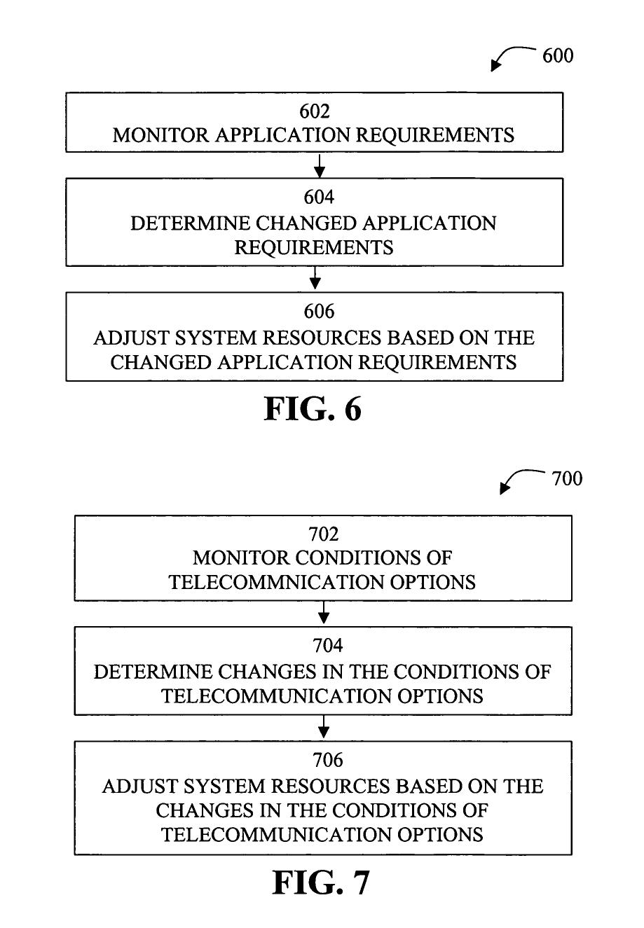

Thus, as application requirements change, the resource manager 100 can adjust system resources accordingly. FIG. 6 shows one aspect of the present invention as a method of monitoring application requirements 600. This method 600 of controlling system resources for applications in use on a computer device involves monitoring application requirements to determine changes and adjusting system resources based on the changed application requirements.

Block 602 illustrates monitoring application requirements 602, such as network connection requirements, that are required by the applications in use. Application requirements may be determined in a variety of ways including but not limited to by tracking system level calls, by tracking memory allocations, and/or by benchmarking application requirements for particular applications.

Block 604 illustrates determining changed application requirements based on changes in the applications in use. For example, the system may be periodically checked to determine which applications are in use and what their requirements are. Applications may be determined in a variety of ways including, but not limited to, by looking at active processes via the operating system and correlating processes to application names.

Block 606 illustrates adjusting system resources based on the changed application requirements. Adjusting system resources may involve selecting a connection option available on a client device based on changed application requirements, enabling the connection option, and disabling connection options not selected. The selection of the connection option may also be based on user and/or company preferences. The selection of the connection option may further be based on a determination of the telecommunications options available at the time of the changes.

FIG. 7 shows a related aspect of the present invention as a method of monitoring telecommunication conditions 700. This method 700 of controlling system resources for applications in use involves monitoring conditions of connection options available on a client device to determine changes and adjusting system resources based on those changes.

Block 702 illustrates monitoring conditions of connection options available on a client device.

Block 704 illustrates determining changes in the conditions of connection options available on the device, For example, the quality of connection can be measured by examining dropped packet statistics, signal strength, and/or actual network speed, among other things.

Block 706 illustrates adjusting system resources based on the changes in the conditions of the connection options. Adjusting system resources may involve selecting and enabling one of the connection options available on the computer device and/or disabling the remaining connection options. The selection of one of the connection options may also be based on user and/or company preferences.

As an example, the resource manager 100 may have previously identified and enabled a Wi-Fi device connection because it offered a higher transmission speed then a cellular connection, based on the user's preferences indicating a preference for the fastest available connection in all circumstances. The user may then move to a different physical location while continuing to use the client device and application requiring network access. If the user moves out of the Wi-Fi hotspot, the cellular connection may offer a faster connection speed than the Wi-Fi connection, which may be lost altogether. In such case, the resource manager 100 will recognize the changed conditions, disable the Wi-Fi connection and components and enable the cellular connection and components. This may be done with or without the user's interaction. The user (and consequently the user's application running on the client device) may be uninterrupted and even unaware of any change. Alternatively, the resource manager 100 could present the user with an option to change when a change in telecommunication conditions occurs. The user's level of control could be set as a user preference. For example, a user could set a preference that requires the resource manager to present options whenever there is telecommunication condition change, only when there is a telecommunication change that will affect cost, or never, among others.

Process for User Interface Control

The resource manager 100 can also provide the user with an alternative to using a conventional operating system interface, such as Windows® from Microsoft Corp. An operating system user interface commonly controls what the user sees and can therefore complicate and interfere with access to a network. Specifically, by controlling the user interface and the content that can go on it, an operating system interface controls the user. Although the operating system interface generally must be online before an application can be used, the resource manager 100 can be interposed between the user and the operating system, as the default or preferred interface instead of an operating system interface, during any or all phases of operation.

The resource manager 100 can use an operating system's resource control functions, such as Windows® “Network Neighborhood” utility, to connect a mobile computer to a network. The resource manager 100 can also use this utility to control the operating system to enable all the network functions necessary to make the user experience an uncomplicated connection to its application. Accordingly, once the operating system is booted, the resource manager 100 can appear and control the connectivity to the network, and can seize control of all operating system functions so that the user accesses these functions via the resource manager 100 instead of a general operating system interface.

The resource manager 100 can also restrict the use of various operating systems functionality if it chooses or if the user desires. The user may be locked out of any application outside of the resource manager 100 interface. In one implementation, the user encounters a resource manager 100 user interface instead of the operating system interface. The resource manager 100 may make this happen automatically so that the user is not aware that it is running on top of the operating system interface. Once the resource manager 100 interface dominates the screen, it can prevent the user from going backward to access the general operating system interface, effectively locking the user out of applications outside of the resource manager 100 interface. The interface screen can then be used to launch applications, which may be an operating system compatible application or other application.

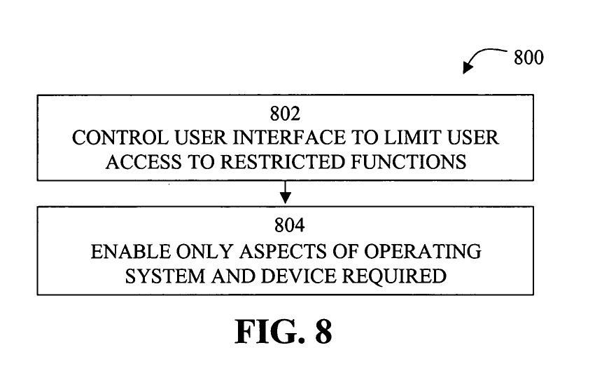

FIG. 8 shows one aspect of the present invention as a method of controlling operating system or platform functions 800. This method 800 of selectively using resources to accomplish a limited function on a client device operating a general-purpose operating system involves limiting a user's access by limiting the user interface on the client device and enabling only required aspects of the operating system.

Block 802 illustrates controlling a user interface on the client device such that the user's access to functions other than the limited function is restricted. For example, a handheld device could be built simply and cheaply with a general-purpose operating system overlain with a resource manager that restricts the devices functions in a way consistent with its resources. More specifically, the device could offer a simple Internet based chat room. The resource manager of the device could prevent the user from accessing the general operating system's functions not intended by the hardware design.

Block 804 illustrates enabling only aspects of the operating system and client device required by the limited function 804. This may similarly be accomplished by controlling the user interface. Only limited functions are enabled through the user interface. The resource manager 100 may provide this limited user interface that enables only certain features available on the general-purpose operating system that underlies it.

One significant benefit of this method and related embodiments of the invention is that the resource manager 100 provides the additional benefit of allowing manufacturers to design mobile computer devices that are tailored for particular applications. The evolution of the Internet has made the general-purpose mobile computer the requisite terminal for Internet access. By utilizing the capabilities available through use of the resource manager 100, computer hardware manufacturers can design application specific client devices such as mobile or non-mobile application-specific electronic products. The resource manager 100 enables a hardware manufacturer to insure network connectivity in a simple fashion independent of what operating system is used. In this sense, the resource manager 100 allows for product optimization. If the application for which the hardware is being designed does not require certain costly components, such as high-resolution and high-speed displays, these components do not have to be used. If the purpose of the device does not require various functions of a general-purpose operating system, the resource manager 100 can disable those functions to enhance the operation of the operating system on the device.

Process for Continuous Access to a Network

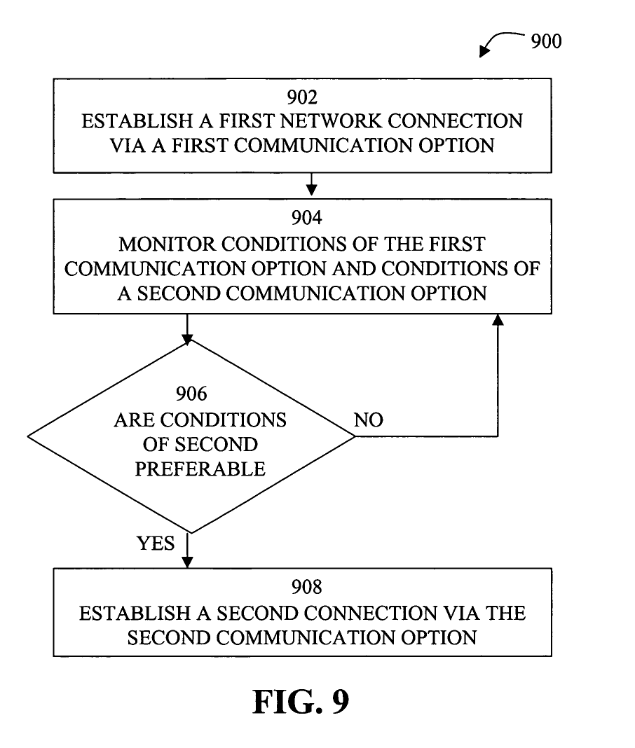

FIG. 9 shows one aspect of the present invention as a method 900 of providing continuous access to a network. This method 900 provides a client device with access to a network and involves establishing a first network connection, monitoring the conditions of that connection and other available connections through other communication options, and switching to a second connection to the network based on a determination that it is preferable to do so.

Block 902 illustrates establishing a first connection to the network via a first communication option available on the device. For example, a mobile computing device could be connected to a network through a dialup modem device over a standard telephone line.

Block 904 illustrates monitoring conditions of the connections available on the first communication option and a second communication option.

Block 906 illustrates determining whether conditions of a connection on the second communication option are preferable to conditions of the connection on the first communication option 906.

Block 908 illustrates establishing a second connection to the network via the second communication option 908 based on the determination of whether conditions of the second communication option are preferable to conditions of the first communication option. This may be accomplished by disconnecting the first connection. The conditions of the second communication option may be determined preferable to conditions of the first communication option because the first communication option is not available or because the second communication option offers faster network access. This determination may also be based in part on user and/or company preferences. For example, a user or company may have a preference of minimizing telecommunications costs, minimizing transmission time, minimizing system resource usage and/or maximizing the life of a battery of the computer device. The telecommunication requirements can be made specific (optimized) to the requirements of the application. For example, these requirements can be set according to such user preferences as cost of the communications service, speed, bandwidth, quality of the signal, and quality of service. Resource manager 100 can automatically “look” for what wireless services are available, and then present choices to the user or automatically make a selection for the user. It can optimize the operation of applications and hardware to accommodate the user's activities, for example by shutting down other communications resources and closing out other applications not being used at the time.

Process for Conserving System Resources

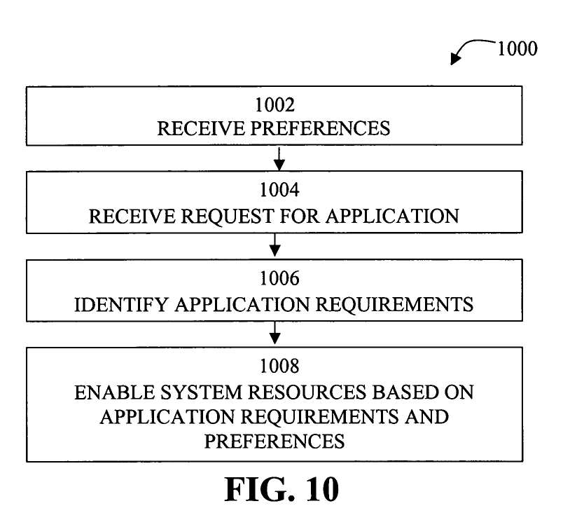

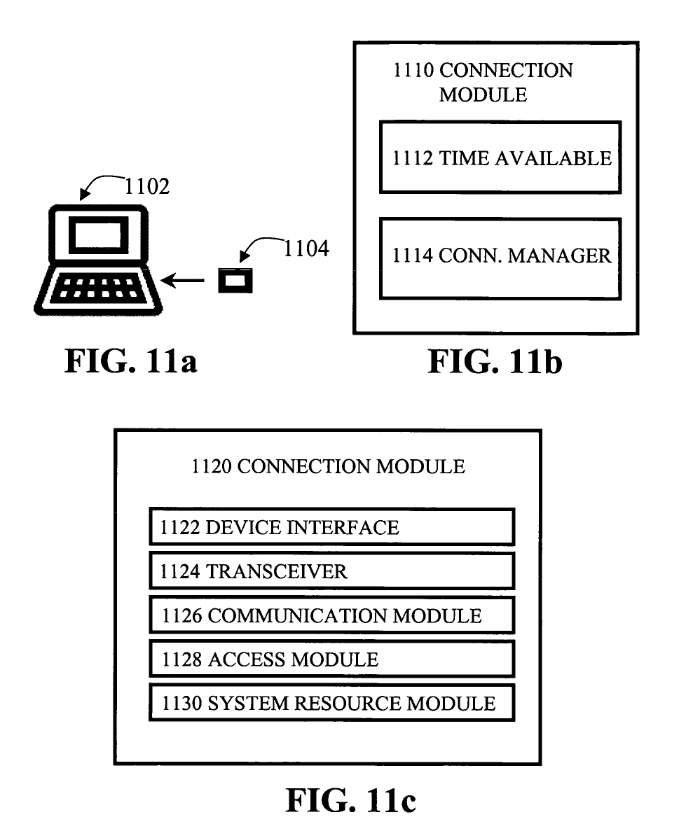

FIG. 10 shows one aspect of the present invention as a method of conserving resources 1000. This method 1000 of conserving system resources may involve receiving preferences and a request for an application, identifying application requirements, and enabling system resources based on the application requirements and the preferences.

In block 1002, preferences are received. This may involve setting preferences at installation of the resource manager 100, if it is a software embodiment. The settings may also be preset prior to installation and may be reset at installation and/or anytime thereafter. Preferences may include a variety of factors and elements that influence the operation of the resource manager 100. For example, a preference for low costs may influence the setting changes made by the resource manager in certain embodiments. The preferences may be user and/or company preferences.

In block 1004, a request for an application is received. For example, a user may click on an icon on the operating system user interface or on a resource manager 100 interface. Clicking on this icon may indicate a request to execute a given application. The resource manager 100 recognizes the user's request for an application.

In block 1006, the resource manager 100 identifies application requirements based on system resources required for the application. This may be accomplished in a variety of ways. Generally, the resource manager will associate a given application or type of application with a given set of resource requirements.

In block 1008, the resource manager enables system resources based on the application requirements and the preferences. The method may also involve disabling system resources based on the application requirements and the preferences.

Another aspect of this method provides controlling a user interface to control the system resources available to a user. The user interface may prevent the user from accessing some of the available system resources or applications. For example, the resource manager 100 can conserve battery power used by the telecommunication and other hardware and software components. Resource manager 100 knows which network connection is in use and can “power down” the other interfaces to conserve battery life of the portable mobile computer. As an example, resource manager 100 can regularly scan the network connections for availability of communications services and identify those available. One way resource manager 100 can accomplish this is to regularly power cycle the appropriate network interface modules to check for changes in network availability. In these cases, resource manager 100 can quickly turn on the appropriate modules, check for network availability, and then turn off the power to the unused modules. This duty cycle will typically be much less that 10% of the time, resulting in power savings of over 90% per network interface module. In many cases, the user may not require any network connections for their current usage, resulting in additional power savings. The intelligent power savings will result in a longer battery life for the portable device. Resource manager 100 may perform these power savings features automatically and independent of the user.

Connection Module

Certain embodiments of the present invention involve a connection module, methods of using a connection module, and methods of selling communications using a connection module. A connection module or telecommunication battery is something that allows access on a number of networks and/or through a number of providers. A connection module can be a device used to add telecommunication ability to an electronic device such as a mobile computer, a PDA, a digital camera, a music player, or a vending machine by providing one or more connections to one or more networks, whether physical connections or wireless. A connection module may or may not be designed to incorporate and utilize resource manager 100 as either stand alone software and hardware in different locations or as a combined component. As described below, some embodiments of the invention include connection modules that do not include a resource manager 100. A connection module may provide, allow, or support Internet access over wireless and/or wired connections. The connection module may include one or more transceivers for wireless connections.

According to one embodiment of the invention, a connection module may include the necessary software, hardware, and airtime to connect to one or more carrier networks. These components are preferably included (prepackaged) into the connection module. For example, a connection module may include one or more transceiver circuits that connect to a number of networks, the appropriate connection software, and prepaid (or otherwise pre-acquired) airtime for one, six, twelve, or twenty-four months. The connection module can also be used to add additional telecommunication capabilities to an electronic device already having some telecommunication abilities.

FIGS. 11a, 11b and 11c depict various connection modules 1104, 1110, 1120 that may be inserted into, attached to, or otherwise made a part of a client device 1102. The connection module 1110 illustrated in FIG. 11b includes time available 1112 and a connection manager 1114.

The connection module 1120 illustrated in FIG. 11c shows a connection module according to certain embodiments that may include a variety of different functional components, including a device interface 1122, a communication module 1126, an access module 1128, and/or a system resource module 1130. Optionally, the connection module may also include one or more transceivers 1124. Accordingly, it may be a connection module comprising an interface for connection to an electronic device, a communication module for establishing connections with one network from the plurality of networks, and an access module for maintaining airtime allotments for the plurality of networks. One or more transceivers may be used for communicating with a plurality of networks. Different embodiments of a connection module according to the present invention may include some or all of these components as well as additional components and functionality. For example, a connection module may also include a system resource control module for controlling the connections and associated system resources.

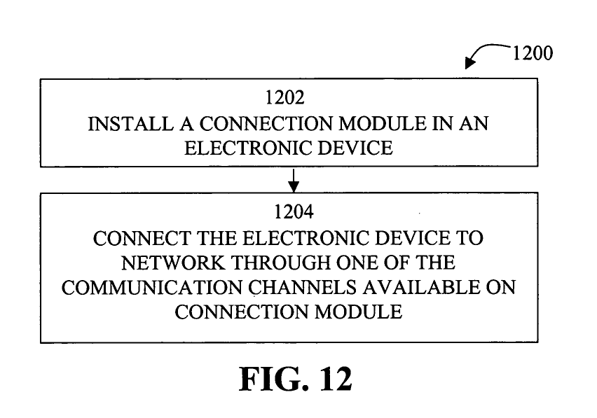

FIG. 12 shows one aspect of the present invention as a method of adding telecommunications capability 1200 to an electronic device. This method 1200 involves using a connection module in an electronic device to connect the electronic device to a network using an available connection.

Block 1202 illustrates installing a connection module capable of connecting to a network through a plurality of connections. The connection module may be installed in the electronic device at time of assembly of the electronic device (i.e. during manufacture), by a subsequent supply chain member (i.e. as an add-on component) prior to end customer purchase, or by the end customer or user (i.e. by separate purchase). The connection module may be integrally associated or inserted with other hardware components, such as part of a processing chip, of an electronic device, or may be removably inserted like a PCMCIA card.

In block 1204, the electronic device is connected to the network through one of the connections available on the connection module. The connection module could offer multiple connection types of the same or different types of communications or it could offer only one type. In this block, a connection is established through one of the available connections.

A connection module may also include airtime such as prepaid airtime. The ability of the connection module to include airtime has many technical and commercial advantages. Specifically, a connection module provider can use this ability to add value to the services provided by a telecommunication network carrier. These value added aspects include the ability to simplify payment, to simplify use of the services, and to bundle multiple connection options together. Accordingly, a connection module provider may act as a reseller of airtime for one or more telecommunication network carriers and add value to the services provided by these carriers. For example, the provider of the connection module can buy airtime at a flat rate from a wireless carrier, and then meter or sell the airtime per minute at a marked up rate as capacity with a connection module. The connection module can include a set capacity for airtime corresponding to a dollar amount regardless of which carriers the connection module chooses to select for various calls or communications. Alternatively, the user can buy the connection module with an account for which he or she provides his or her credit card number; whenever it is running low on airtime, the connection module can access the user's credit card account and prepurchase a set or desired increment of time. The connection module can also have access to a number of credit card accounts of the user, and may choose which account to use depending on factors having to do with the credit card accounts such as interest rate, frequent user credits, promotions, and other relevant factors.

A connection module provides advantages in the area of payment because the payment for the telecommunication services can be associated with the cost of the connection module. The purchaser of the connection module is able to pay for the telecommunication services in a manner that is most convenient for her. For, example, a purchaser may select a connection module that has prepaid telecommunication services for one, six, twelve, or twenty-four months. Another purchaser may select a connection module that has airtime or telecommunication charges that are paid periodically based on usage. These charges can be automatically billed to the purchaser's credit card.

A connection module may also provide value added advantages by improving the ease of use of the telecommunication services. When a connection module includes the necessary software, hardware, and airtime, these components can be managed to provide a convenient, simple to use, interface for the user. Resource manager 100 can provide this management ability and user interface. A connection module may also add value by bundling multiple connection options together into one device. Users require access to networks at different times, in different places, and in different ways. A connection module can include multiple telecommunications options to account for a user's various needs. In addition, a connection module may coordinate and manage the use of these telecommunications options. Resource manager 100 can also provide this management ability.

A connection module may also be called a telecom battery because it may be plugged into or include as part of an electronic device. Used in this manner, a connection module is analogous to an electric battery. Just as an electric battery can be plugged into an electronic device to add electricity to the device, a connection module may be plugged into an electronic device to add telecommunication capability such as, for example, a PCMCIA card. For example, a plug-in type connection module can be bought by an end consumer at a retail outlet and plugged into the user's PDA or computer, adding telecommunication ability to the device. Alternatively, rather than plugging into an electronic device, a connection module can be included as a component of an electronic device prior to sale of the device to the consumer. For example, if the connection module is included in a PDA by the PDA manufacturer or OEM, the product may have telecommunication ability available at the time of purchase.

Connection modules can also be specialized for certain applications. A variety of different connection modules satisfy various functions of specific applications just as there are different sizes and power levels of electric batteries. For example, the telecommunication requirements of a given digital camera may be very different than the telecommunication requirements of a PDA. Different connection modules may be used to satisfy these different requirements.

Connection modules also allow telecommunication costs to be minimized to the requirements of the application and allow these cost savings to be passed on to the users. One example is to price the connection module based on the imposition on network capacity that the specific application will require. For smaller data amounts and slower speed requirements a cheaper connection module can be offered. Likewise, if the data direction is in the up link direction a cheaper connection module may be offered if telecommunication costs in that direction are less expensive to provide.

One connection module embodiment provides for the packaged sale of telecommunication with either general or application specific telecommunication capabilities. The price of the connection modules may reflect the length of time the connection module will provide telecommunications. For example, a one-month connection module, a six-month connection module, a twelve-month connection module, and a twenty-four-month connection module may be available at different prices. The price of the connection module may also reflect the application for which the connection module will be used or the user's preferences. One user may prefer higher speeds for a given application than another. Another user may prefer lower costs over higher speeds.

A connection module may be sold in the same stores that sell portable computers and other electronic devices. This provides convenience for a customer who can purchase a connection module at the same store she purchased her notebook computer. The connection module can be packaged as an electronic device and a compact disc that allows the connection module to be used for the purchase period. For example, the compact disc can allow use of a connection module for one, six, twelve, or twenty-four months depending on the user's preference. These four time periods are used for purposes of demonstration and are not meant to limit the invention. Other time periods and marketing promotions are envisioned. The sale of telecommunication capability and capacity as part of a hardware component allows all of the sales and marketing advantages inherent in hardware promotion to be used in addition to the sales and marketing techniques available for telecommunications services.

In certain embodiments, the connection manager can be viewed as a battery of prepaid or pre-acquired network access. The consumer expends the network access (for example the time available 1112 shown in FIG. 11b) stored on the connection module when the user or an application running on the user's device connects to the network through the connection manager. It should be noted that sign-on, and/or authorization, authentication may be accomplished automatically and/or without the user's input or knowledge. The amount of network access (time available) that is consumed by network access may depend on a variety of factors. For example, the amount of network access consumed may depend upon the type of connection (WWAN, WLAN, LAN, Dial-up, etc.), usage time, and amount of data, time-of-day usage, among other factors. Accordingly, some access may be free, some access cheap, and other access expensive in terms of usage of the stored network access. A user may view the current status of the network access remaining on the connection module and may be notified when the network access remaining hits a low threshold or is close to expiration. The user may chose to refill, recharge, or otherwise re-acquire network access on the connection module. Connection to the network may be automatic or the user may select from connection options effecting the connection characteristics (speed, etc.) and connection module (use of stored network access). Accordingly, one of the many advantages of certain embodiments of the connection module is to make internet access simple for a consumer by allowing automatic connection and network sign-on, providing consumer electronics with connection modules with stored network access, and by providing an improved user experience. Other advantages result from the use of certain embodiments of the connection module with certain embodiments of the resource manager 100.

The resource manager 100 can manage the telecommunication requirements and user interaction with the functions available on a connection module. The resource manager 100 can manage the telecommunication connections and hardware components on a device taking into account certain parameters. These parameters include the applications the connection module will be enabling, the connection options available, and the user/company preferences.

The resource manager 100 may also be used to facilitate the use of a connection module to provide a connection to a network through changing telecommunications channels or options. An electronic device may have multiple network communication options. These options may be provided by a connection module and/or by other components of the electronic device. The resource manager 100 can control and utilize an appropriate network communication option, automatically, based on user-defined criteria, or upon approval by the user after presenting the user with an array of options. In addition, the resource manager 100 may be used to maintain a connection using several data streams or packet streams and can filter or accelerate the flow of data based on the requirements of the application to provide optimal connection to the network. In other words, the user can experience a continuous or near continuous connection to the network in accordance with their preferences even when the resource manager 100 is adjusting, managing, and switching among different network communication options. For example, as a mobile user moves about using a portable electronic device containing a connection module, different network communication options may become available or preferable. The resource manager 100 can switch to an appropriate connection when it becomes available or preferable with or without the user's interaction.

The resource manager 100 may also facilitate the ability of an application specific connection module on a more general-purpose machine. Accordingly, the resource manager 100 can deal with the potential problem of an application specific connection module being used to provide telecommunications for another purpose on a general-purpose electronic device. Specifically, the resource manager 100 has the ability to restrict the user's access to the more general functions that may be available on an electronic device while the connection module is in use. This may be accomplished, for example, by using a user interface that does not allow the user to access applications outside of the user interface. The user is locked-out of restricted functions.

Process for Remote Control and Regulation

There are many remote control and remote monitoring advantages that result when resource manager 100 is used with a connection module. These advantages include the ability to manage upgrades on remote portable devices, the ability to monitor and use location information for the portable device, the ability to remotely control applications, and the ability to enable and simplify data recovery and continuity when a telecommunication channel is interrupted.

Resource manager 100 allows for the management of upgrades on remote portable devices in a secure environment. This upgrade functionality extends across all applications. Resource manager 100 can keep track of the applications available on a remote device, keep track of the providers of those applications, keep track of when the applications are changed and when upgrades are available, and keep track of how different upgrades are performed. With these capabilities, resource manager 100 can perform upgrades on a push or pull basis. The remote portable device can recognize and initiate its own upgrade procedure or an upgrade can be initiated elsewhere on the network. For example, a company wishing to roll out a new software upgrade to all of its sales associates in the field can initiate and manage such an upgrade using resource manager 100. The company can also use resource manager 100 to send upgrades out to a specific remote machine by using the connection module to identify the appropriate remote portable device.

Using resource manager 100 with a connection module may provide the ability to monitor the location of a remote portable device. This location information is useful to both the remote, portable device itself and to companies wishing to track the location of their portable computers in the field. The remote, portable device can use the location information on the device and on its local applications. For example, resource manager 100 can use this information to change the time when a time zone is crossed. As another example, resource manager 100 can change the telecommunications options or preferences as the user's location changes.

Companies may also use the location information available with the use of connection modules. For example, when remote portable device are accessing a company's network, a resource manager 100 on each of these devices can communicate the location information to appropriate company personnel or devices. This location information can be used in a variety of ways by the company, such as identifying which sales associate or field technician is currently closest to one of the company's clients or customers. Such information may be very useful in the event of a customer emergency that required, for example, a visit from a technician to perform tests using a specific diagnostic software application. The company can identify both an appropriate field technicians in the proximate location to the emergency and can also determine whether the portable device carried by that person contained the necessary diagnostic software.

Using a resource manager 100 with a connection module may also provide the ability to remotely control a portable device associated with a company. For example, the company can use a resource manager 100 to ensure that the portable device is not used to download pornography. As another example, in the event the portable device is stolen or an employee carrying a portable device is terminated, a resource manager 100 can be used to remotely delete confidential information saved on the portable device.

Process for Data Recovery

Resource manager 100 also provides data recovery and protection against the loss of data. This ability is useful when a resource manager 100 is used with a connection module. Resource manager 100 may capture information in the event that a telecommunication channel is interrupted or discontinued. For example, if a removable connection module is pulled out while a user is working on a remote network application, the resource manager 100 may capture and/or save the information. When another connection to the network is established, the resource manager 100 provides the captured information. This data recovery function prevents or at least minimizes data loss associated with lost and interrupted connections.

Furthermore, this function allows for the continuous use of network applications even through changing communication channels. The resource manager 100 accomplishes this function by capturing the necessary information when a connection through one connection option is terminated and restoring the data to the application when another connection is established to the network through the same or another connection option. These features offer the additional benefits of simplifying the user's experience by automating a continuous network connection.

### ALTERNATIVE EMBODIMENTS

The structures and processes described above illustrate a exemplary embodiments of inventive concepts included in the present invention. Other systems and processes are possible. While the invention has been described in detail with particular references to these particular embodiments, variations and modifications can be affected within the spirit and scope of the invention as described in this document. Nothing in this specification is meant to limit, expressly or implicitly, the plain meaning of the terms used in the following claims.

That which is claimed:

1. A method of controlling system resources on a client device comprising:
determining application requirements for at least some of the applications currently in use on the client device, wherein the applications currently in use are running on an operating system having operating system resource settings associated with client device system resources;
determining client device system resource requirements based on the application requirements; and
adjusting the operating system resource settings to optimize use of system resources based on the client device system resource requirements.

2. The method of claim 1 wherein adjusting the operating system resource settings comprises disabling client device system resources not needed to satisfy the client device system resource requirements.

3. The method of claim 2 wherein disabling client device system resources not needed to satisfy the client device system resource requirements comprises discontinuing provision of power to the system resources.

4. The method of claim 1 wherein adjusting the operating system resource settings comprises enabling client device system resources needed to satisfy the client device system resource requirements.

5. The method of claim 4 wherein enabling client device system resources comprises providing power to the system resources.

6. The method of claim 1 further comprising monitoring the application requirements for all applications currently in use on the client device.

7. The method of claim 6 further comprising:
determining changes in application requirements based on changes in the applications in use on the client device; and
adjusting the operating system resource settings to optimize the system resource usage based on the changes.

8. The method of claim 1 wherein the client device is capable of having more than one application in use at a time.

9. The method of claim 1 wherein the client device is a mobile computing device.

10. The method of claim 1 wherein the client device is a laptop computer.

11. A method of controlling system resources on a client device comprising:
determining application network connectivity requirements for at least some of the applications currently in use on the client device;
determining communication resource requirements based on the application network connectivity requirements; and
adjusting system resource settings to optimize system resource usage based on the communication resource requirements.

12. The method of claim 11 wherein the network is the Internet.

13. The method of claim 11 wherein the network is a local area network.

14. The method of claim 11 wherein adjusting system resource settings to optimize system resource usage comprises:
selecting a connection option available at the client device based on the application requirements of the applications in use; and
enabling the connection option on the client device.

15. The method of claim 14 wherein selecting the connection option is also based on user preferences.

16. The method of claim 14 wherein selecting the connection option is also based on company preferences.

17. The method of claim 14 wherein the connection option is a local area network interface.

18. The method of claim 14 wherein the connection option is a dial up interface.

19. The method of claim 14 wherein the connection option is a wireless interface.

20. The method of claim 14 wherein the connection option is a Wi-Fi interface.

21. The method of claim 14 wherein the connection option is a wireless wide area network interface.

22. A method of controlling system resources for applications in use on a client device comprising:
monitoring application requirements required by the applications in use wherein the application requirements comprise requirements for connection to a network;
determining changed application requirements based on changes in the applications in use on the client device wherein the changes include changes in the requirements for connection to a network; and
adjusting system resources based on the changed application requirements.

23. The method of claim 22 wherein adjusting system resources based on the changed application requirements comprises:
selecting a connection option available on the client device based on the changed application requirements; and
enabling the connection option on the client device.

24. The method of claim 23 further comprising disabling connection options not selected.

25. The method of claim 23 wherein selecting the connection option is also based on user preferences.

26. The method of claim 23 wherein selecting the connection option is also based on company preferences.

27. The method of claim 23 further comprising determining the telecommunications options available at the time of the changes.

28. A method of controlling system resources for applications in use on a client device comprising:
periodically testing conditions of connection options available on the client device to determine changes in the conditions of connection options available on the client device; and
adjusting system resources based on the changes in the conditions of the connection options available on the client device.

29. The method of claim 28 wherein adjusting system resources based on the changes in the conditions of the connection options available on the client device comprises selecting and enabling one of the connection options available on the client device.

30. The method of claim 28 further comprising disabling remaining connection options.

31. The method of claim 28 wherein selecting one of the connection options is also based on user preferences.

32. The method of claim 28 wherein selecting one of the connection options is also based on company preferences.

33. A method of conserving system resources comprising:
receiving preferences for performance on a client device;
receiving a request for an application on a client device;
identifying application requirements based on system resources required for the application; and
enabling system resources based on the application requirements and the preferences.

34. The method of claim 33 wherein the preferences are user preferences.

35. The method of claim 33 wherein the preferences are company preferences.

36. The method of claim 33 further comprising disabling system resources based on the application requirements and the preferences.

37. The method of claim 33 further comprising controlling a user interface to control the system resources available to a user.

38. The method of claim 37 wherein the user interface prevents the user from accessing some of the available system resources.

39. The method of claim 33 further comprising controlling a user interface to control the applications available to a user.

40. The method of claim 39 wherein the user interface prevents the user from accessing some of the available applications.

41. A method of providing a client device access to a network comprising:
establishing a first connection to the network via a first communication option available on the client device;
periodically testing conditions of the first communication option and a second communication option available on the client device; and
establishing a second connection to the network via the second communication option based on a determination of whether conditions of the second communication option are preferable to conditions of the first communication option.

42. The method of claim 41 further comprising disconnecting the first connection.

43. The method of claim 41 wherein the conditions of the second communication option are preferable to conditions of the first communication option because the first communication option is not available.

44. The method of claim 41 wherein the conditions of the second communication option are preferable to conditions of the first communication option because the conditions of the second communication option offer faster network access.

45. The method of claim 41 wherein the determination of whether the conditions of the second communication option are preferable to conditions of the first communication option is based on user preferences.

46. The method of claim 41 wherein the determination of whether the conditions of the second communication option are preferable to conditions of the first communication option is based on company preferences.

47. The method of claim 41 wherein the determination of whether the conditions of the second communication option are preferable to conditions of the first communication option is based on a preference of minimizing telecommunications costs.

48. The method of claim 41 wherein the determination of whether the conditions of the second communication option are preferable to conditions of the first communication option is based on a preference of minimizing transmission time.

49. The method of claim 41 wherein the determination of whether the conditions of the second communication option are preferable to conditions of the first communication option is based on a preference of minimizing system resource usage.

50. The method of claim 41 wherein the determination of whether the conditions of the second communication option are preferable to conditions of the first communication option is based on a preference of maximizing the life of a battery of the client device.

51. A method of selectively using resources to accomplish a limited function on a client device operating a general purpose operating system comprising:
controlling a user interface on the client device such that the user's access to functions other than the limited function is restricted; and
enabling only aspects of the operating system and client device required by the limited function.

52. A connection module comprising:
an amount of stored network access; and
a connection manager for managing the use of the stored network access.

53. A connection module comprising:
an interface for connection to an electronic device;
a connection module for establishing network connections; and
an access module for maintaining airtime allotments.

54. The device of claim 53 further comprising a transceiver for communicating with the network.

55. The device of claim 53 further comprising a system resource control module for controlling the connections and associated system resources.

56. The device of claim 53 permanently installed in an electronic device to add telecommunications capability.

57. The device of claim 53 removably installed in an electronic device to add telecommunications capability.

58. The device of claim 53 capable of establishing a network connection through two or more communications options.

59. The device of claim 58 wherein network connections through two or more communication options are offered through at least two telecommunication network carriers.

60. The device of claim 53 further comprising airtime corresponding to a set value regardless of which carrier provides the network connection.

61. The device of claim 53 further comprising airtime corresponding to a user account.

62. The device of claim 61 wherein the user account is a credit card account.

63. The device of claim 61 wherein the user account is a prepaid account.

64. The device of claim 61 wherein the user account is rechargeable.

65. The device of claim 53 further comprising network access corresponding to a set value.

66. The device of claim 53 further comprising airtime corresponding to a user account.

67. The device of claim 66 wherein the user account is a credit card account.

68. The device of claim 66 wherein the user account is a prepaid account.

69. The device of claim 66 wherein the user account is rechargeable.

70. The device of claim 53 further comprising a resource manager to manage system resources.

71. The device of claim 53 wherein the device is specialized for a specific application.

72. A method of providing telecommunications capability to an electronic device comprising:
providing a connection module capable of connecting to a network through a plurality of connections;
installing the connection module in the electronic device; and
connecting the electronic device to the network through one of the connections.

73. The method of claim 72 wherein the connection module contains airtime.

74. The method of claim 73 wherein the connection module monitors airtime usage on the plurality of connections.

75. The method of claim 73 further comprising recharging the airtime.

76. The method of claim 72 wherein the connection module contains an amount of stored network access.

77. The method of claim 75 wherein the connection module monitors network usage and adjusts the stored network access based on the network usage.

78. The method of claim 76 further comprising recharging the amount of stored network access.
